(19) United States
(12) Patent Application Publication
(10) Pub. No.: US 2013/0200182 A1
(43) Pub. Date: Aug. 8, 2013

(54) PROCESS FOR OBTAINING APATITE CONCENTRATES BY FROTH FLOTATION

(71) Applicants: Sebastião Eduardo De Rezende, Araxa (BR); Josiane Silvia Martins, Araxa (BR); Elves Matiolo, Araxa (BR); Lauro Akira Takata, Araxa (BR)

(72) Inventors: Sebastião Eduardo De Rezende, Araxa (BR); Josiane Silvia Martins, Araxa (BR); Elves Matiolo, Araxa (BR); Lauro Akira Takata, Araxa (BR)

(21) Appl. No.: 13/837,018

(22) Filed: Mar. 15, 2013

Related U.S. Application Data
(63) Continuation-in-part of application No. 13/377,729, filed on Dec. 12, 2011.

(51) Int. Cl. B02C 23/08

(52) U.S. Cl. CPC B02C 23/08
USPC 241/24.1

(57) ABSTRACT

A process applicable to different lithologies of phosphate ore with siliceous-carbonated matrix from igneous or sedimentary origin rocks includes ore preparation by comminution through crushing, grinding, and de-sliming, prior to apatite flotation. During flotation, ground and de-slimed ore pulp with high concentration of solids, above 40%, is initially conditioned with depressant reagent, e.g., a vegetable starch gelatinized with sodium hydroxide solution, and conditioning with collector reagent (sulphosuccinate or sulphosuccinamate). This conditioned pulp floats apatite in a circuit with rougher, scavenger, cleaner and recleaner flotation steps. CO₂ gas can be added in all or some flotation steps to a bubble generation system. The synthetic apatite collector provides selective flotation of apatite and carbonates from silicates and other gangue minerals in the rougher and scavenger flotation steps, while the combination of effects of the synthetic collector with CO₂ gas provides selective apatite flotation from the carbonates in the cleaner and recleaner steps.

### CROSS-REFERENCE TO RELATED APPLICATIONS

This application is:
a continuation-in-part of co-pending U.S. patent application Ser. No. 13/377,729, filed on Jun. 9, 2010 (which application claims the priority, under 35 U.S.C. §§119, 120, 363, and 371, of Brazilian patent application No. PI0902233-3 filed on Jun. 9, 2009, and International Application No. PCT/BR2010/00183 filed on Jun. 9, 2010, which designated the United States and was published in English),
   the entire disclosures of which are hereby incorporated herein by reference in their entireties.

### STATEMENT REGARDING FEDERALLY SPONSORED RESEARCH OR DEVELOPMENT

Not Applicable

### FIELD OF THE INVENTION

The present invention relates to a process in mineral technology. More specifically, the present invention relates to the apatite concentration by froth flotation from phosphates ores with a predominantly siliceous-carbonated matrix, for example, sedimentary or igneous rocks.

### BACKGROUND OF THE INVENTION

In order to reach an adequate separation of mineral components in ore it is necessary to liberate and separate the mineral of interest from the gangue minerals. The steps for this separation include reducing ore particle sizes to allow a physical separation of such components. Depending on the kind of minerals, the sequence of treatments must be adjusted accordingly, using physical properties like color, radioactivity, density, magnetic susceptibility, electrostatic conductivity, etc. Froth flotation is a process more frequently used in the mineral industry, due to the good performance of the process, giving good selectivity and high recoveries for mineral separation processes. The froth flotation process includes, basically, the use of chemical reagents to modify surface properties of minerals to be floated and the minerals to be depressed. In the flotation machines, the minerals to be floated must have a hydrophobic behavior and the minerals to be depressed must have a hydrophilic behavior. The hydrophobic particles of ores form agglomerates with particles exhibiting the same behavior and gas bubbles to be floated as a froth of the flotation process. The hydrophilic particles remain in the pulp as a sink flow. Generally, for surface modification of the mineral particles by chemical reagents, the ore pulp with high solids concentration is previously conditioned in mechanically agitated tanks with specific reagents.

The apatite concentration in the ores containing variable amounts of silicates and carbonates has been presented as a great challenge in many phosphate ores throughout the world, either for sedimentary or magmatic origins. Over decades, researchers all around the world have dedicated themselves to studying methods of selective separation between the apatite and carbonates, mainly calcite and dolomite. The apatite flotation process is normally carried out in alkaline pH, using vegetable starch as a depressant of gangue minerals and fatty acid as an apatite collector. The main problem is that carbonates have the same behavior of the apatite in these conditions and using those reagents to separate the apatite and carbonates becomes almost impossible.

An exemplary prior art embodiment of ore preparation steps is shown in the scheme of FIG. 1. Therein, the ore preparation by crushing, grinding and desliming involves, in all steps, known processes in the actual state of the art in the mineral industries. In step 105, the ore is provided. In steps 110 and 115, the ore is crushed and homogenized, respectively. At steps 120 and 125, grinding is performed using a rod mill and a ball mill, respectively. At step 130, the material is deslimed. Step 135 produces a slime having particles of less than 10 μm. At step 140, flotation is performed, which produces ground and deslimed ore pulp having particles of 350 μm-10 μm.

U.S. Pat. No. 4,339,331 to Lim at al. has suggested the use of a vegetal starch dissolved in alkali as a selective depressant in the flotation of non-sulfide mineral ores, with special emphasis being given to the separation of siliceous gangue particles from oxidic iron values, of copper minerals from molybdenite, of apatite from ilmenite, among others.

U.S. Pat. No. 4,568,454 to Mehrotra teaches the use of carbon dioxide in the beneficiation of high carbonate phosphate rock. The raw material to be treated includes phosphate ores containing high dolomite content. The carbon dioxide combined with an anionic collector assists in the selective separation of the carbonate impurities and the phosphate rock during the flotation reaction. Preferred anionic collectors include soaps, tall oil and sodium oleate.

U.S. Pat. No. 4,814,070 to Koester et al. teaches the use of alkyl sulfosuccinates based on ethoxylated alcohols as a scavenger in a flotation process for non-sulfide mineral ores. The product can be present as esters or as semiesters of sulfosuccinic acid, and as alkali metal or ammonium salts. On the other hand, it has been found that alkyl sulfosuccinates based in ethoxylated alcohols do not always have favorable frothing properties for flotation or a good collector effect.

U.S. Pat. No. 5,147,528 to Bulatovic teaches a process for phosphate beneficiation in which a phosphate containing ore is grinded to provide apatite and gangue release. Certainly, grinding is a common technique used for treating ores in which the particles are reduced to an adequate size.

U.S. Pat. No. 6,805,242 to Sotillo teaches desliming by use of hydrocyclones. Hydrocyclone devices were developed to capture fine particles from the environment. Therefore, if the most fine mineral particles are not welcome to the process, they must be removed to permit classification of particles in a range of sizes desired. Thus, desliming takes part of the process as a whole and the use of hydrocyclones is a question of choice.

In Brazil, the applicant operates an industrial unit of concentration at Cajati-SP, in which the apatite mineral is separated from carbonates, silicates, iron oxides and other mineral gangues by direct flotation of apatite using synthetic collector and corn starch as a depressant of carbonates and other gangue minerals. This process of apatite concentration was applied to other rocks of igneous origin from different regions of Brazil, but all the studies concerning this matter showed negative results, mainly due to the difficulties of the selective separation between apatite and carbonates. On the other hand, research of processes involving apatite and carbonates flotation followed by reverse flotation of carbonates gave poor selectivity due to the difficulties in efficiently depressing apatite in the carbonates flotation.

Thus, a need exists to overcome the problems with the prior art systems, designs, and processes as discussed above.

### SUMMARY OF THE INVENTION

The present invention is applicable to different lithologies of phosphate ores with siliceous-carbonated matrix from igneous and sedimentary origin rocks. The process includes ore preparation by comminution using crushing and grinding, followed by desliming prior to the apatite flotation. At the flotation step, ground and deslimed ore pulp with high solids concentration, e.g., above 40%, is conditioned with depressor reagent, e.g., a vegetable starch gelatinized by sodium hydroxide solution, followed by synthetic collector conditioning selected from sulphosuccinate or sulphosuccinamate groups. This conditioned pulp goes to flotation circuit where apatite is floated in a circuit with rougher, scavenger, cleaner and recleaner flotation steps. Carbon dioxide gas (CO₂) can be added in all flotation steps or only in the cleaner and recleaner steps in the bubble generation system. The synthetic apatite collector provide selective flotation of apatite and carbonates from silicates and another gangue minerals in the rougher and scavenger flotation steps, while the combination of effects of synthetic collector with carbon dioxide gas (CO₂) gives a selective apatite flotation from the carbonates in the cleaner and recleaner steps. The small bubbles of carbon dioxide in the pulp provide a reaction of this gas with water from the pulp to produce carbonic acid and this acid is responsible for this slightly acid pH, between 5.8 and 6.8 depending of the amount of carbonates in the pulp. The depressing effects on the carbonated minerals come from combined action of carbon dioxide gas (CO₂) and the slightly acid pH of the pulp. The carbon dioxide gas (CO₂) would be replaced by a mixture of carbon dioxide gas and atmospheric or compressed air in different proportions. However, in one exemplary embodiment, there is a limit of air in the mixtures that is equal or less than 70% in volume. The scavenger tailing is the final tailing and the recleaner concentrate is the final apatite concentrate.

The invention provides a process for obtaining apatite concentrates that overcomes the hereinafore-mentioned disadvantages of the heretofore-known devices and methods of this general type and that provide such features using a flotation circuit.

With the foregoing and other objects in view, there is provided, in accordance with the invention, a process for obtaining apatite concentrates by froth flotation from phosphate ores with a substantially siliceous-carbonated matrix from igneous and sedimentary origin. Ore pulp is prepared according to a process that includes crushing, grinding and desliming. The ore pulp is conditioned using a collector reagent selected from one of the sulphosuccinate and sulphosuccinamate groups. Carbon dioxide gas is used in the flotation circuit. Using carbon dioxide gas achieves selective flotation for apatite and carbonates from silicates and other mineral gangues in rougher and scavenger flotation steps. Using carbon dioxide gas also achieves selective apatite flotation from the carbonates in cleaner and recleaner flotation steps.

In accordance with another mode of the invention, the carbon dioxide gas is added only in the cleaner and recleaner steps.

In accordance with a further mode of the invention, the carbon dioxide gas is added in all flotation steps.

In accordance with an added mode of the invention, the carbon dioxide gas added in the cleaner and recleaner flotation steps reacts with water from the ore pulp to form carbonic acid and ionization of the carbonic acid creates hydrogen cation, which brings a pH of the ore pulp to slightly acid field, between 5.8 and 6.8.

In accordance with an additional mode of the invention, carbon dioxide gas (CO₂) is injected at the bubble generation system of the flotation machines.

In accordance with a concomitant mode of the invention, a mixture of carbon dioxide gas (CO₂) and air is used in different proportions to replace pure carbon dioxide gas (CO₂), the volume of air in the mixture being less than 70%.

The present invention differs from U.S. Pat. No. 4,339,331 to Lim at al. in that it aims to separate apatite from carbonates present in lithologies of phosphate ore with siliceous-carbonated matrix from igneous or sedimentary origin rocks, therefore, rocks with different properties and characteristics.

The present invention does not use the collectors cited in U.S. Pat. No. 4,568,454 to Mehrotra. In the present invention, the carbon oxide is added preferentially in specific steps of the flotation process (cleaner and recleaner), however, the carbon oxide can be added in all the steps.

In the process of the present invention, sodium sulphosuccinate has presented good results as compared to U.S. Pat. No. 4,814,070 to Koester et al.

The present invention has applied a similar method to that described above with regard to U.S. Pat. No. 5,147,528 to Bulatovic, but selects the best range of particle size, mainly because a mixture of ores from different regions is used in order to compose the raw material. Thus, the preparation of the raw material represents a preliminary step to initiate the flotation process properly.

Although the invention is illustrated and described herein as embodied in a process for obtaining apatite concentrates, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a flow diagram illustrating a schematic representation of a prior art embodiment of ore preparation steps; and

FIG. 2 is a flow diagram illustrating a schematic representation of one exemplary embodiment of a flotation process.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

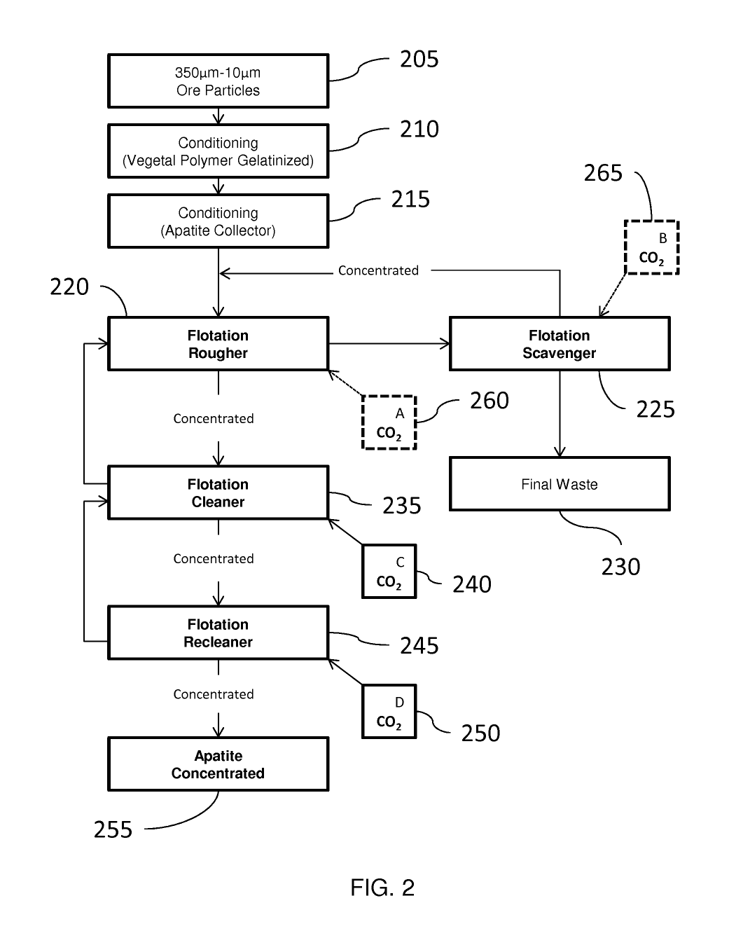

Disclosed is a process applicable to different lithologies of phosphate ore with siliceous-carbonated matrix from igneous or sedimentary origin rocks. The process includes ore preparation by comminution through crushing and grinding, followed by desliming, prior to the apatite flotation. In the flotation step, ground and de-slimed ore pulp with high concentration of solids, e.g., above 40%, is initially conditioned with a depressant reagent, a vegetable starch gelatinized with sodium hydroxide solution, followed by conditioning with collector reagent selected from sulphosuccinate or sulphosuccinamate groups. The collector reagent may be a pure synthetic apatite collector. This conditioned pulp goes to a flotation circuit where apatite is floated in a circuit with rougher, scavenger, cleaner and recleaner flotation steps. The carbon dioxide gas (CO₂) can be added in all flotation steps or only in the cleaner and recleaner steps (C and D—FIG. 2) to the bubble generation system. The synthetic apatite collector provides selective flotation of apatite and carbonates from silicates and other gangue minerals in the rougher and scavenger flotation steps, while the combination of effects of the synthetic collector with carbon dioxide gas (CO₂) provides selective apatite flotation from the carbonates in the cleaner and recleaner steps. The small bubbles of carbon dioxide in the pulp cause a reaction of this gas with water from the pulp to produce carbonic acid and this acid is responsible for this slightly acid pH, between 5.8 and 6.8 depending of the amount of carbonates in the pulp. The depressing effects on the carbonated minerals are due to the combined action of carbon dioxide gas (CO₂) and the slightly acid pH of the pulp. The carbon dioxide gas (CO₂) can replaced by a mixture of carbon dioxide gas and atmospheric or compressed air in different proportions, but there is a limit of the air in these gases mixture, which is 70% or less in volume. The scavenger tailing is the final tailing and the recleaner concentrate is the final apatite concentrate.

A significant point of innovation provided by the present invention is the use of pure synthetic apatite collector to achieve selective apatite and carbonates flotation from silicates and other gangue minerals in the rougher and scavenger flotation steps and the use of carbon dioxide gas (CO₂) to have depressing effects on the carbonates at the cleaner and recleaner flotation steps.

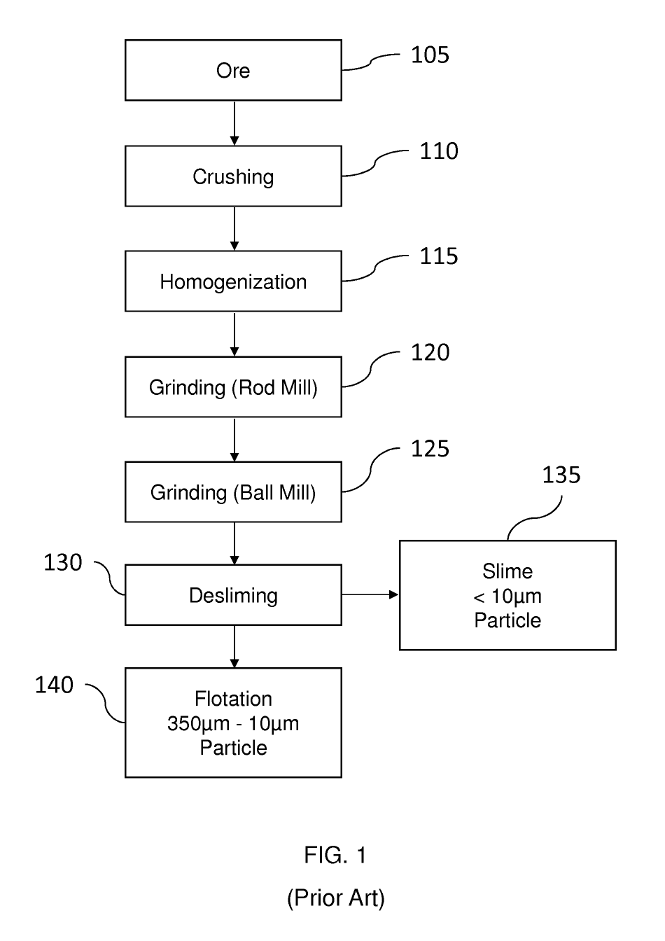

Described now are exemplary embodiments of the present invention. Referring now to the figures of the drawings in detail and first, particularly to FIG. 2, there is shown a schematic representation of an exemplary embodiment of a novel flotation process. The flotation process in FIG. 2 is implemented in a flotation circuit having elements that correspond to the steps in the process. As shown in FIG. 2, the ground and deslimed ore pulp as prepared, for example, in the steps of FIG. 1, is introduced at step 205. At step 210, the flotation process starts with conditioning the ground and deslimed ore pulp with depressant reagent for silicates and Fe₂O₃ bearing minerals. In one exemplary embodiment, the depressant reagent is a vegetable starch gelatinized by sodium hydroxide solution. Just after the first conditioning, at step 215, the ore pulp is conditioned a second time with an apatite collector reagent. In one exemplary embodiment, the apatite collector reagent is provided from one of the sulphosuccinate or sulphosuccinamate groups. The flotation circuit is configured to have rougher 220, scavenger 225, cleaner 235, and recleaner 245 steps, where the rougher 220 and scavenger 225 steps are the apatite recovery flotation steps, and the cleaner 235 and recleaner 245 steps are flotation steps to achieve good concentrate quality. The carbon dioxide gas (CO₂) can be added in all flotation steps (A 260, B 265, C 240 and D 250). However, in one exemplary embodiment, the carbon dioxide gas (CO₂) can be added in only the cleaner 235 and recleaner 245 flotation steps (C 240 and D 250) in order to achieve good overall apatite recovery and to have adequate process selectivity to produce apatite concentrates with high P₂O₅ contents. By lowering the carbonic gas dosages, the flotation process becomes more economical. The rougher 220 and scavenger 225 flotation with air bubbles provides a slightly alkaline flotation in these steps, because of the presence of carbonates and because of the sodium hydroxide solution used for starch gelatinization. In this condition, the apatite flotation becomes less selective from carbonates and both minerals are floated in these recovery steps of flotation. The carbon dioxide gas (CO₂) added in the cleaner 235 and recleaner 245 flotation steps (C 240 and D 250) reacts with water from the ore pulp to form carbonic acid and the ionization of this acid creates hydrogen cation, which brings the flotation pulp pH to a slightly acid field, between 5.8 and 6.8. These two conditions, the action of carbon dioxide gas (CO₂) on the carbonate minerals surfaces and the slightly acid pH, provides as a result a selective apatite flotation from the carbonates. In one exemplary embodiment, a combination of carbonic gas with compressed air in different levels of concentration can be used in place of carbon dioxide gas (CO₂) by air in approximately 70% in volume.

In this flotation circuit, the scavenger 225 flotation step is fed by rougher 220 tailing, e.g., waste, flow, the scavenger tailing is the final tailing and the scavenger concentrate is re-circulated to a rougher 220 feed. Rougher 220 flotation is fed by conditioned pulp that comes from conditioning step 215 and rougher concentrate goes to cleaner flotation step 235. Cleaner 235 tailing comes back to rougher 220 flotation step and cleaner 235 concentrate goes to recleaner 245 flotation, whose tailing comes back to cleaner 235 flotation. Recleaner 245 concentrate is the final concentrate of this flotation circuit. Concentrated apatite is provided as a result in step 255. The circulating load of the flotation circuit is necessary to improve the apatite recovery of the flotation process.

The carbon dioxide gas (CO₂) addition to the bubble generation system is performed using air aspirated flotation machines or other systems that use compressed air or air blowers. Using a pressure gauge and a gas flowmeter is necessary for both air and carbon dioxide gas (CO₂) control.

### EXAMPLES

### Example 1

A sample of phosphate ore with siliceous-carbonated matrix, named phlogopitite, from Chapadao mine at Catalao-GO comprising 8.24% P₂O₅, 28.61% CaO, 17.43% Fe₂O₃, 6.65% SiO₂ and 9.84% MgO, is submitted to crushing, homogenization, grinding and desliming operations. An aliquot of the prepared sample, with 1000 grams, is transformed in a pulp with about 50% of solids by weight and conditioned with corn starch gelatinized with NaOH solution, followed by conditioning with sodium sulphosuccinate. This pulp is then floated in a bench scale mechanical cell, simulating rougher, cleaner and recleaner steps in an open circuit, without circulating load. The rougher flotation is carried out without pH correction. The aim of the rougher flotation is a recovery of apatite and carbonates from silicates and other gangue minerals. In the cleaner and recleaner flotation steps, the air is totally replaced by carbon dioxide gas (CO₂) to depress the carbonate minerals in the apatite flotation. In one exemplary embodiment, the final concentrate presented is a P₂O₅ grade of 37.3% and overall apatite recovery of 72.5%.

### Example 2

Several aliquots of a sample prepared according to Example 1 are transformed into pulp in a mechanical agitated tank to obtain a solids concentration around 45% by weight. This pulp is fed to a pilot plant with two conditioners using two 2-inch diameter columns in series to run continuous apatite flotation test work. The feed rate of this pilot plant is 10 kg/h and in the first conditioner, the pulp is conditioned with depressant reagent, e.g., a corn starch gelatinized by NaOH solution, followed by conditioning with a sodium sulphosuccinate-based apatite collector. The flotation is performed with a circuit having rougher and cleaner steps assembled with 2-inch columns. In the rougher column, the flotation is performed using only compressed air in the bubble generation system. In the cleaner column, in one exemplary embodiment, carbon dioxide gas (CO₂) can be replaced by air in different levels of combination, going from pure carbon dioxide gas (CO₂) to pure air. In one exemplary embodiment, carbonic gas can be replaced by air by about 70% in terms of flow rate. In one exemplary embodiment, the final concentrate presented is a P₂O₅ grade of 34.4% and overall recovery of 64.3%.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A process for obtaining apatite concentrates by froth flotation from phosphate ores with a substantially siliceous-carbonated matrix from igneous and sedimentary origin, which comprises:
by crushing, grinding and desliming ore to create an ore pulp;
conditioning the ore pulp with a collector reagent selected from at least one of the groups including sulphosuccinate groups and sulphosuccinamate groups;
applying carbon dioxide gas in at least part of a flotation circuit to achieve, with the carbon dioxide, at least one of:
selective flotation for apatite and carbonates from silicates and other mineral gangues in rougher flotation and scavenger flotation steps; and
selective apatite flotation from the carbonates in cleaner flotation and recleaner flotation steps.

2. The process for obtaining apatite concentrates by froth flotation according to claim 1, which further comprises adding the carbon dioxide gas only in the cleaner flotation and recleaner flotation steps.

3. The process for obtaining apatite concentrates by froth flotation according to claim 1, which further comprises adding the carbon dioxide gas in all of the flotation steps.

4. The process for obtaining apatite concentrates by froth flotation according to claim 1, which further comprises adding the carbon dioxide gas cleaner and recleaner flotation steps, this added carbon dioxide gas reacting with water from the ore pulp to form carbonic acid and ionization of the carbonic acid creates hydrogen cation, which brings a pH of the ore pulp towards an acidity of between 5.8 and 6.8.

5. The process for obtaining apatite concentrates by froth flotation according to claim 1, which further comprises:
carrying out at least some of the flotation steps with at least one flotation machine having a bubble generation system; and
injecting carbon dioxide gas (CO₂) at the bubble generation system of the at least one flotation machine.

6. The process for obtaining apatite concentrates by froth flotation according to claim 1, which further comprises utilizing a mixture of carbon dioxide gas (CO₂) and air in different proportions to replace pure carbon dioxide gas (CO₂), the volume of air in the mixture being less than 70%.
